(19) United States
(12) Patent Application Publication
(10) Pub. No.: US 2012/0310917 A1
(43) Pub. Date: Dec. 6, 2012

(54) Accelerated Join Process in Relational Database Management System

(75) Inventors: Vadim Sheinin, Mount Kisco, NY (US); Hangu Yeo, Baldwin Place, NY (US)

(73) Assignee: INTERNATIONAL BUSINESS MACHINES CORPORATION, Armonk, NY (US)

(21) Appl. No.: 13/149,180

(22) Filed: May 31, 2011

(51) Int. Cl. G06F 17/30

(52) U.S. Cl. 707/714; 707/E17.054

(57) ABSTRACT

Techniques are provided for an accelerated join process in a relational database management system. The disclosed join method partitions a plurality of input records using a hash-based technique to form a plurality of partitioned blocks. The partitioned blocks are sorted to form sorted partitioned blocks. The sorted partitioned blocks are then compressed to form a plurality of compressed blocks of records. The compressed blocks of records are stored for each partition in a storage system. The compressed blocks of records associated with a pair of partitions can then be loaded into a main memory. The loaded compressed blocks of records are then decompressed and the decompressed blocks of records are merged into associated merged partitions. Finally, two of the merged partitions are joined by comparing records from each merged partition. In a multi-threaded implementation, multiple pairs of merged partitions can be joined in parallel.

### FIELD OF THE INVENTION

The present invention relates generally to accelerating external join operations in a Relational Data Base Management System (DBMS) when neither of two input relations or tables can be loaded into main memory.

### BACKGROUND OF THE INVENTION

A join operation is an important and time consuming operation in a relational database system. Generally, a join operation attempts to merge two tables by finding records with matching keys in the tables. When the two input relations can be fully loaded into main memory, the records are joined recursively using an internal join operation. When the two input relations cannot be loaded into main memory, however, the two input relations are partitioned into sub-relations (partitions) and each partition is stored in secondary memory (storage system). Pairs of partitions are loaded from the storage system to main memory sequentially, and the records within partitions are joined recursively (using an external join operation).

A hash join algorithm is commonly used in database systems to implement equi-joins efficiently. In a build phase, a hash table is created using a smaller relation (referred to as a build relation), and then in a probe phase, this hash table is probed using a larger relation (referred to as a probe relation) to find matches between the two relations. A hybrid hash join algorithm is an external join operation developed to handle the case where the main memory available is too small to hold the input relations. In the hybrid hash join algorithm, the two relations are partitioned such that each partition and corresponding hash table can fit within the main memory, and pairs of build and probe partitions are joined sequentially. Only a pair of partitions is loaded in the main memory, and the rest of the partitions of input relations are stored in the storage device.

The above-described join algorithms suffer from a number of limitations, which if overcome, could further improve the accuracy and efficiency of the join operation. First, the join operation can be I/O bound with a multithreaded parallel implementation of the join operation on a multi-core architecture. Second, the hybrid hash join operation cannot be used when the join is not based on an equality operation. Third, the hash table implementation is not an easy task. For example, the dynamic hash table creating operation, such as inserting elements, takes time proportional to the number of elements in most cases where the build records are not presorted based on their hash code values.

A need therefore exists for improved methods and apparatus for performing accelerated join operations in a relational database management system.

### SUMMARY OF THE INVENTION

Generally, techniques are provided for an accelerated join process in a relational database management system. According to one aspect of the invention, a join method is provided for a relational database that partitions a plurality of input records using a hash-based technique to form a plurality of partitioned blocks. The partitioned blocks are sorted to form sorted partitioned blocks. The sorted partitioned blocks are then compressed to form a plurality of compressed blocks of records. The compressed blocks of records are stored for each partition in a storage system. The compressed blocks of records associated with a pair of partitions can then be loaded into a main memory. The loaded compressed blocks of records are then decompressed and the decompressed blocks of records are merged into associated merged partitions. Finally, two of the merged partitions are joined by comparing records from each merged partition.

The partitioned input records may comprise a number of partitions based on an output hash code value. In addition, the partitioned input records can each be stored in a corresponding output buffer.

The sorting sort the partitioned input records, for example, using a key attribute. Further, the partitioning may partition the input relations, for example, into sub-relations with uniformly distributed sizes. Matched records following the comparison of records from each merged partition can be sent to to a join operation client as an output. In a further multi-threaded implementation, multiple pairs of merged partitions can be joined in parallel.

A more complete understanding of the present invention, as well as further features and advantages of the present invention, will be obtained by reference to the following detailed description and drawings.

### BRIEF DESCRIPTION OF THE DRAWINGS

FIG. 1 is a schematic representation of an external join operation system incorporating features of the present invention;

FIG. 2 illustrates a functional architecture of an exemplary external join operation incorporating features of the present invention;

FIG. 3 illustrates a structure of partitions stored in a storage system;

FIG. 4 illustrates the storage of compressed blocks of records for each partition in a storage system; and

FIG. 5 illustrates the loading of compressed blocks of records from a storage system into main memory for a merge join operation in accordance with the present invention.

### DETAILED DESCRIPTION OF PREFERRED EMBODIMENTS

The present invention provides accelerated external join operations in a relational database management system when both input relations are too large to fit in main memory. According to one aspect of the invention, the disclosed method includes a hash based partitioning, sorting and data compression technique and an external merge join operation with presorted partitions loaded from a storage system as inputs. The disclosed method partitions input relations into sub-relations using a hash based technique, which creates sub-relations (partitions) with uniform sizes. The sorting and data compression techniques are applied to relatively small blocks of records (which are already hashed into partitions) to avoid an expensive external sorting and to save storage space and bandwidth between a processing element and a storage device.

It has been found that the combined presorting and data compression technique using entropy encoding can save about 30% in terms of compressed partition size stored in secondary memory. Small blocks of records that are read back from the storage device are merged to create a pair of sorted partitions within main memory, and joined using a comparison operation.

Although the merge join operation itself is a fast join technique, the merge join operation is considered an expensive method as the merge join algorithm requires both relations sorted by the key attributes to be joined, and the external sorting operation is not a cheap operation especially when the size of the input relation is large. However, if the small sized input blocks of records to the merge join operation are already presorted without any additional preprocessing process, the merge join algorithm outperforms other available join operations including a hash join algorithm by taking advantage of presorted blocks of records. In the disclosed system, since each block of records within the partitions that are read back from the storage system are already fully sorted blocks, the fast join operation can be directly applied to the pairs of partitions sequentially by combining each record from one partition with matching records from the other partition.

FIG. 1 is a schematic representation of an external join operation system 100 incorporating features of the present invention. The two input relations to the join operation are read sequentially from the storage system 110 along path 104. If the sizes of both relations are small and can be loaded into main memory 102 a recursive-type join operation can be performed within the processor 101 without storing input relations in the storage device 103. The join operation produces the set of matched records from both relations, and the output of the join operation is returned and stored back in the storage system 106.

When the input relations do not fit in main memory 102, however the input relations are subdivided into smaller pieces, i.e., sub-relations (partitions), using hashed key attributes and the partitions are stored in a storage system 103. Hence, the join operation with two large relations becomes multiple join operations with a pair of partitions. Each join operation is performed sequentially using a pair of partitions loaded from storage system 103 into main memory 102, and the output of each join operation is stored in the storage system 110.

Each join operation using a pair of partitions is independent from each other. Thus, each join operation can be parallelized so that multiple threads can handle multiple join operations concurrently within the processor 101. The parallelized multi-threaded join operation is a fast process, and may cause I/O bound. The present invention recognizes that a compression of partitioned relations can reduce storage usage on the storage system 103 as well as bandwidth to store and read back partitioned relations 104 and 105.

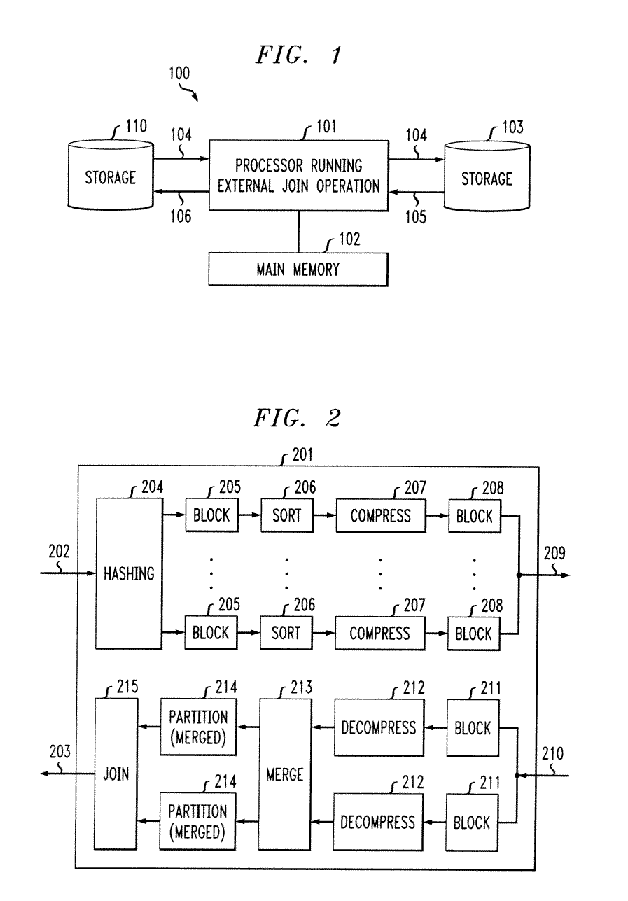

FIG. 2 illustrates a functional architecture of an exemplary external join operation incorporating features of the present invention. As shown in FIG. 2 an external join operation is performed in a processor 201. When the input records are loaded at path 202, each record is hashed into partitions using a hash algorithm 204 with a key attribute as an input. The partition number is determined by an exemplary 32 bit output hash code value, and the hashed records are stored in output buffers, and each buffer is allocated for each partition. Each block of records 205 is sorted at stage 206 by key attribute, and the sorted blocks of records are compressed at stage 207 (for example, using an entropy coding technique), and the compressed blocks of records 208 for each partition is stored in a storage system along a path 209. The internal sorting of a small block of records is relatively cheap in terms of computation compared with an external sorting algorithm, and it has been found that the presorting and data compression technique using an exemplary entropy encoding can save approximately 30% in terms of compressed partition size stored in the storage device.

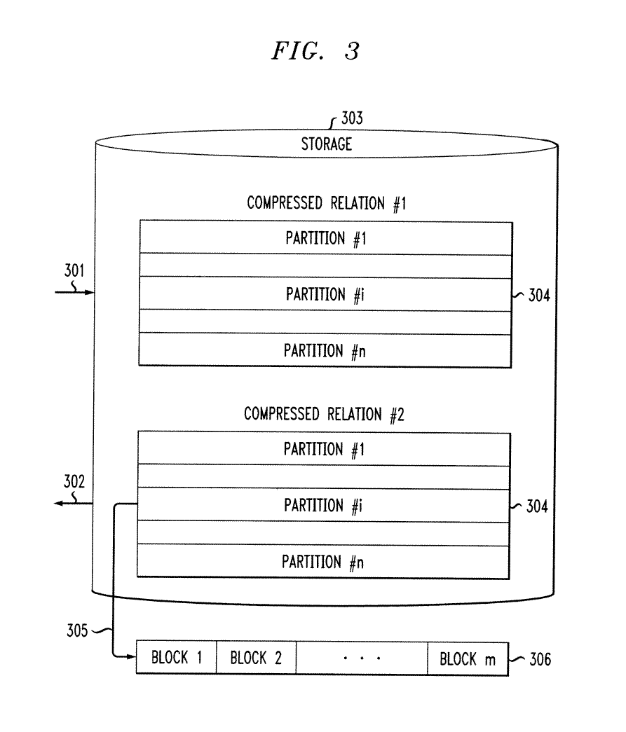

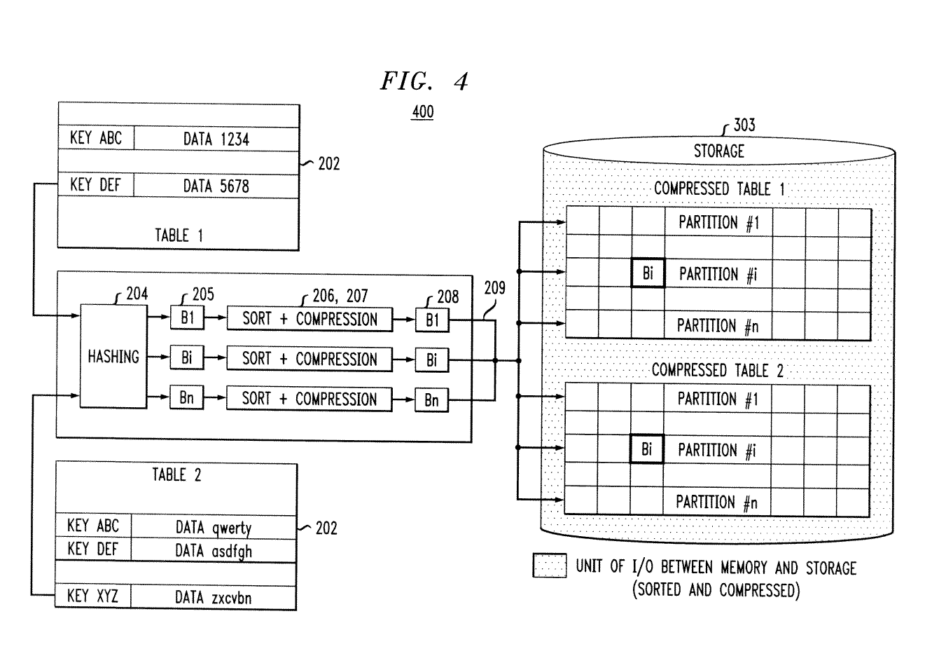

FIG. 3 illustrates a structure of partitions 304 stored in a storage system 303. In particular, FIG. 3 illustrates a structure of sub-relations (partitions) 304 stored in the storage system 303. The two input relations are partitioned into the same number, n, of partitions 304 with a uniformly distributed number of records across partitions because the same hashing algorithm is applied on the same key attribute.

As shown in FIG. 3 for an exemplary partition 305, each partition 305 is composed of equally sized blocks 306, and the join operation is performed at a block granularity. With a single threaded implementation of a join operation, one pair of partitions is joined at a time and each pair of partitions is loaded to main memory one after another. On the other hand, with multi-threaded implementation of a join operation, multiple pairs of partitions are joined in parallel, and a compression scheme can speed-up the parallel join operation.

As illustrated in FIG. 2, a pair of blocks from a pair of partitions is loaded to main memory for a join operation, and each block 211 is decompressed at stage 212, and the n presorted blocks will be merged at stage 213 into a single partition 214. Since the partitions 214 to be joined are already presorted on a join column, the actual join process 215 is relatively simple and fast, i.e. the join operation only needs to obtain a record from each input partition and compares them, and the matched records are sent to the storage system as an output.

The disclosed efficient compression technique, combined with a fast internal sorting algorithm, can resolve the bandwidth burden to feed records needed by a fully optimized parallel execution of multiple join operations, and the performance of the join process improves dramatically by taking advantage of presorted records as well.

FIG. 4 illustrates the storage of compressed blocks of records 208 for each partition in the storage system 303 of FIG. 3. In particular, FIG. 4 illustrates the hashing 205 of input records loaded from path 202, and the subsequent sorting 206 and compression 207, prior to the storage of storage of compressed blocks of records 208 in system 303 along a path 209. Corresponding numbers from FIG. 2 have been employed in FIG. 4 for ease of reference.

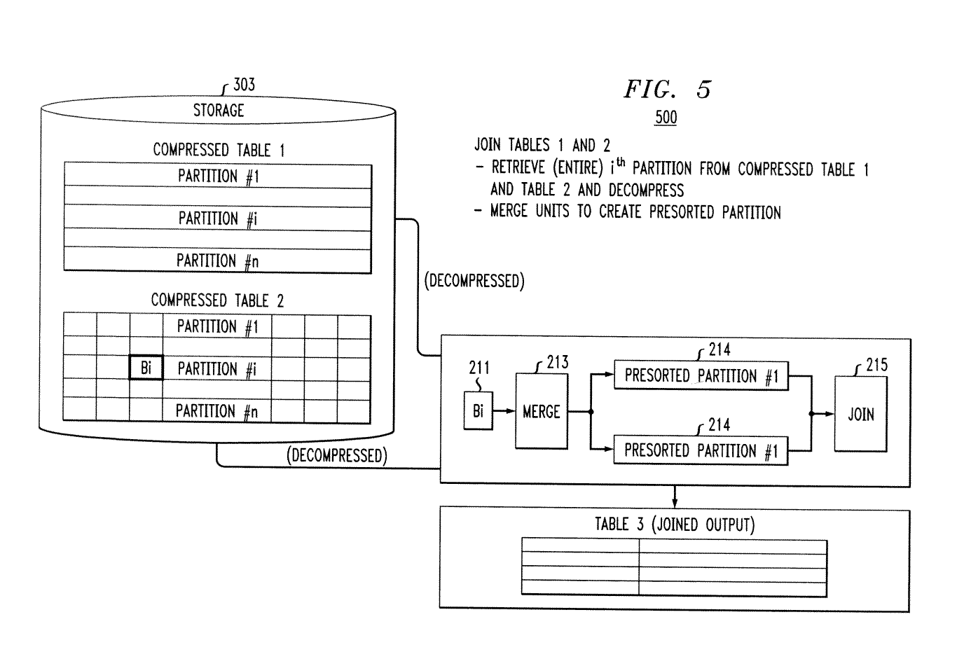

FIG. 5 illustrates the loading of compressed blocks of records 211 from storage system 303 into a main memory associated with a processor for a merge join operation. Corresponding numbers from FIG. 2 have been employed in FIG. 5 for ease of reference. In particular, FIG. 5 illustrates the merging of n presorted blocks at stage 213 into partitions 214. The join operation 215 obtains a record from each input partition 214 and compares them, and the matched records are sent to the storage system as an output.

Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer).

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor coupled directly or indirectly to memory elements, for example, through a system bus. The memory elements can include local memory employed during actual implementation of the program code, bulk storage, and cache memories which provide temporary storage of at least some program code in order to reduce the number of times code must be retrieved from bulk storage during implementation.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the FIGS. illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Method steps described herein may be tied, for example, to a general purpose computer programmed to carry out such steps, or to hardware for carrying out such steps, as described herein. Further, method steps described herein, including, for example, obtaining data streams and encoding the streams, may also be tied to physical sensors, such as cameras or microphones, from whence the data streams are obtained.

It should be noted that any of the methods described herein can include an additional step of providing a system comprising distinct software modules embodied on a computer readable storage medium. The method steps can then be carried out using the distinct software modules and/or sub-modules of the system, as described above, executing on one or more hardware processors. In some cases, specialized hardware may be employed to implement one or more of the functions described here. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A join method for a relational database, comprising:
partitioning a plurality of input records using a hash-based technique to form a plurality of partitioned blocks;
sorting said partitioned blocks to form sorted partitioned blocks;
compressing said sorted partitioned blocks to form a plurality of compressed blocks of records;
storing said compressed blocks of records for each partition in a storage system;
loading said compressed blocks of records associated with a pair of partitions into a main memory;
decompressing said loaded compressed blocks of records;
merging said decompressed blocks of records into associated merged partitions; and
joining two of said merged partitions by comparing records from each merged partition.

2. The method of claim 1, wherein said hash-based technique employs a key attribute as an input.

3. The method of claim 1, wherein said partitioned input records comprise a number of partitions based on an output hash code value.

4. The method of claim 1, wherein said partitioned input records are each stored in a corresponding output buffer.

5. The method of claim 1, wherein said sorting step sorts said partitioned input records using a key attribute.

6. The method of claim 1, wherein said partitioning step partitions input relations into sub-relations with uniformly distributed sizes.

7. The method of claim 1, further comprising the step of sending matched records following said comparison of records from each merged partition to a join operation client as an output.

8. The method of claim 1, wherein a multi-threaded implementation joins multiple pairs of merged partitions in parallel.

9. A system for implementing a join method for a relational database, said system comprising:
a memory; and
at least one processor, coupled to the memory, operative to:
partition a plurality of input records using a hash-based technique to form a plurality of partitioned blocks;
sort said partitioned blocks to form sorted partitioned blocks;
compress said sorted partitioned blocks to form a plurality of compressed blocks of records;
store said compressed blocks of records for each partition in a storage system;
load said compressed blocks of records associated with a pair of partitions into a main memory;
decompress said loaded compressed blocks of records;
merge said decompressed blocks of records into associated merged partitions; and
join two of said merged partitions by comparing records from each merged partition.

10. The system of claim 9, wherein said hash-based technique employs a key attribute as an input.

11. The system of claim 9, wherein said partitioned input records comprise a number of partitions based on an output hash code value.

12. The system of claim 9, wherein said partitioned input records are each stored in a corresponding output buffer.

13. The system of claim 9, wherein said partitioned input records are sorted using a key attribute.

14. The system of claim 9, wherein said input relations are partitioned into sub-relations with uniformly distributed sizes.

15. The system of claim 9, wherein said processor is further configured to send matched records following said comparison of records from each merged partition to a join operation client as an output.

16. The system of claim 9, wherein a multi-threaded implementation joins multiple pairs of merged partitions in parallel.

17. An article of manufacture for a join method for a relational database, said article of manufacture comprising a tangible machine readable recordable medium containing one or more programs which when executed implement the steps of:
partitioning a plurality of input records using a hash-based technique to form a plurality of partitioned blocks;
sorting said partitioned blocks to form sorted partitioned blocks;
compressing said sorted partitioned blocks to form a plurality of compressed blocks of records;
storing said compressed blocks of records for each partition in a storage system;
loading said compressed blocks of records associated with a pair of partitions into a main memory;
decompressing said loaded compressed blocks of records;
merging said decompressed blocks of records into associated merged partitions; and
joining two of said merged partitions by comparing records from each merged partition.

18. The article of manufacture of claim 17, wherein said partitioned input records comprise a number of partitions based on an output hash code value.

19. The article of manufacture of claim 17, wherein said sorting step sorts said partitioned input records using a key attribute.

20. The article of manufacture of claim 17, wherein said partitioning step partitions input relations into sub-relations with uniformly distributed sizes.
